(19) United States
(12) Patent Application Publication
(10) Pub. No.: US 2010/0050419 A1
(43) Pub. Date: Mar. 4, 2010

(54) MACHINE TOOL ASSEMBLY WITH MOVABLE MACHINE TOOL

(76) Inventor: Amihud Rabin, Tel Aviv (IL)

Correspondence Address: David Klein;DEKEL PATENT LTD., Beit HaRof'im, 18 Menuha VeNahala Street, Room 27, REHOVOT, IL

(21) Appl. No.: 12/202,271

(22) Filed: Aug. 31, 2008

(51) Int. Cl. B23Q 3/157; B23Q 5/50

(52) U.S. Cl. 29/563; 483/57

(57) ABSTRACT

A machine tool assembly including a first machine tool including a spindle for holding a cutting tool and at least one machine table for mounting thereon a workpiece, a second machine tool for mounting thereon a workpiece, and a conveying unit for moving the second machine tool back and forth from a storage position in a storage compartment of the first machine tool to a machining position wherein the second machine tool is mounted on the at least one machine table of the first machine tool.

### FIELD OF THE INVENTION

The present invention relates generally to machine tools, and particularly to a machine tool assembly in which another machine tool (e.g., a rotary device) can be moved back and forth at will from a storage position to a machining position in order to increase the number of axes for linear and rotational manipulations of workpieces or tools.

### BACKGROUND OF THE INVENTION

Machine tool assemblies, especially those that employ computerized numerically controlled (CNC) machine tools, generally include a number of machine tools for different machining operations with varying numbers of axes for linear and rotational manipulations of the tools and workpieces. Although it is possible to convey a machine tool from one place in the manufacturing site to another in order to provide additional degrees of freedom in machining a part, this is a cumbersome and expensive procedure.

### SUMMARY OF THE INVENTION

The present invention seeks to provide methods and apparatus for machine tool assembly in which another machine tool (e.g., a rotary device) can be moved back and forth at will from a storage position to a machining position in order to increase the number of axes for linear and rotational manipulations of workpieces or tools, as is described more in detail hereinbelow.

There is thus provided in accordance with an embodiment of the present invention a machine tool assembly including a first machine tool including a spindle for holding a cutting tool and at least one machine table for mounting thereon a workpiece, a second machine tool for mounting thereon a workpiece, and a conveying unit for moving the second machine tool back and forth from a storage position in a storage compartment of the first machine tool to a machining position wherein the second machine tool is mounted on the at least one machine table of the first machine tool.

The first machine tool may include a first machine table that moves along a first axis. The first machine table may be slidingly mounted on a base (which may serve as a second machine table) for moving along a second axis orthogonal to the first axis.

The second machine tool may include a rotary device capable of rotational manipulations with respect to a multiplicity of axes.

The storage compartment may be provided with a door. The conveying unit may be supported from a hoist trolley, which is arranged to move along a trolley beam.

A connection unit may be provided with cables for the second machine tool, the connection unit moving along a support beam.

There is also provided in accordance with an embodiment of the present invention a method for machining including providing a first machine tool including a spindle for holding a cutting tool and at least one machine table for mounting thereon a workpiece, a second machine tool for mounting thereon a workpiece, and a conveying unit for moving the second machine tool back and forth from a storage position in a storage compartment of the first machine tool to a machining position wherein the second machine tool is mounted on the at least one machine table of the first machine tool, and using the conveying unit to convey the second machine tool from the storage position to the machining position and machining a workpiece.

### BRIEF DESCRIPTION OF THE DRAWINGS

The present invention will be understood and appreciated more fully from the following detailed description taken in conjunction with the drawings in which:

FIGS. 1 and 2 are simplified illustrations of a machine tool assembly, in accordance with an embodiment of the present invention, including a rotary device in a storage position and a machining position respectively;

FIG. 3 is a simplified illustration of a second machine tool of the machine tool assembly sitting idle on a machine table, and a relatively small workpiece clamped for 3D milling on a limited surface of the machine table, in accordance with an embodiment of the present invention; and

FIG. 4 is a simplified illustration of a relatively large second machine tool installed on the machine table for performing 5 D machining of a workpiece, in accordance with an embodiment of the present invention, wherein no surface of the machine table is available for 3D milling.

### DETAILED DESCRIPTION OF EMBODIMENTS

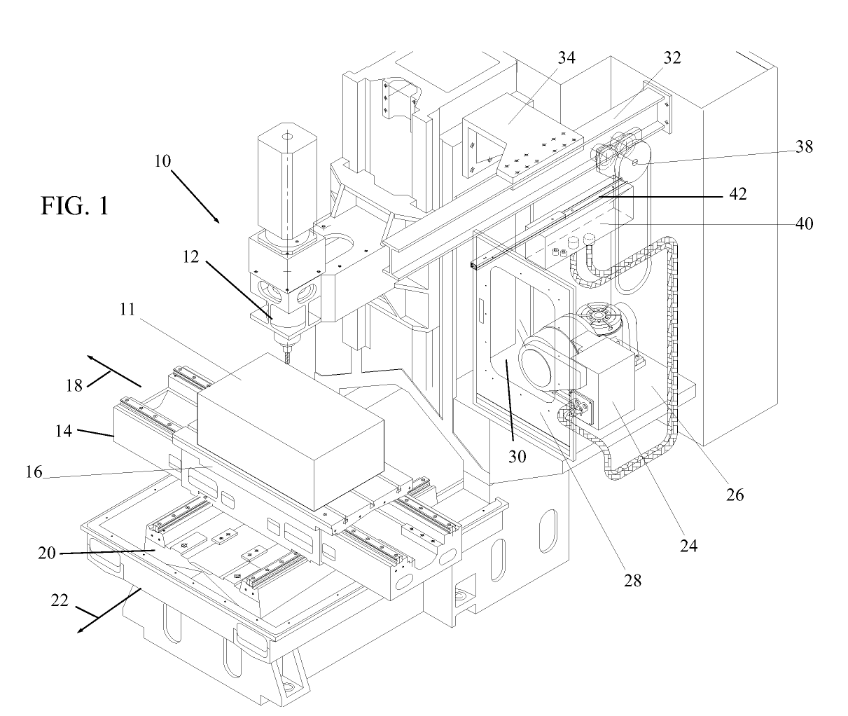

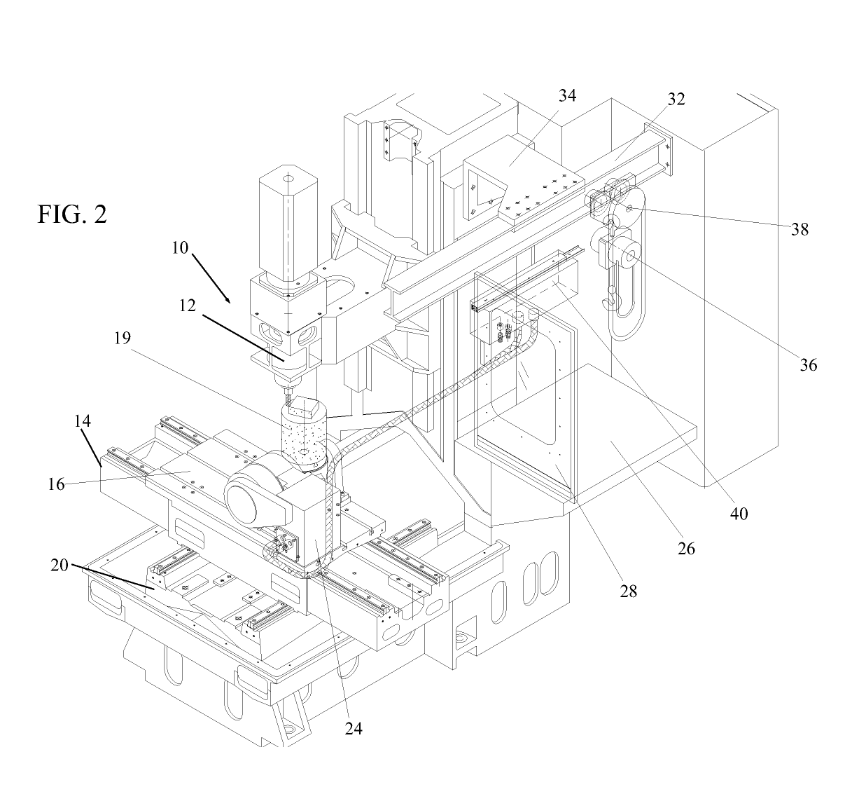

Reference is now made to FIGS. 1 and 2, which illustrate a machine tool assembly, in accordance with a non-limiting embodiment of the present invention.

The machine tool assembly includes a first machine tool 10 that includes a spindle 12 for chucking and holding different cutting tools (millers, drills, etc.), and a saddle 14 with a machine table 16 that moves along a first axis 18. Saddle 14 may be stationary, or as illustrated in the non-limiting embodiment, may be slidingly mounted on a base 20 for moving along a second axis 22, orthogonal to first axis 18. In FIG. 1, a workpiece 11 is mounted on machine table 16 and occupies most of the first machine table surface.

The machine tool assembly includes a second machine tool 24, which can be moved back and forth from a storage position (FIG. 1) to a machining position (FIG. 2), as will now be explained.

Second machine tool 24 is preferably, although not necessarily, a rotary or tilt device, such as with the capability of rotational manipulations of workpieces or tools with respect to five or more axes or any other number of axes. In the storage position, second machine tool 24 rests on a storage rack 26 in a storage compartment 28 of the first machine tool 10 of the machine tool assembly. The compartment 28 may be provided with a door 30. It is noted that the term “storage compartment” refers to any suitable storage place for the machine tool to rest upon.

Second machine tool 24 is arranged for moving from compartment 28 out to first machine tool 10. For example, a trolley beam 32 may be provided above second machine tool 24 attached to the body of the first machine tool 10 by means of a beam support 34. A conveying unit 36 (e.g., an electromechanical, pneumatic or hydraulic hoist or other lifting mechanism) is supported from a hoist trolley 38, which is arranged to move along trolley beam 32. A connection unit 40 is provided with cables (e.g., electrical cables and hydraulic/pneumatic lines) for second machine tool 24. Connection unit 40 moves along a support beam 42.

Conveying unit 36 is coupled to second machine tool 24 (e.g., by means of cables, ropes and the like) and lifts second machine tool 24 out of compartment 28, through an opening or through door 30 which has been opened (by a suitable control device, not shown, or manually), and slides along trolley beam 32 until second machine tool 24 reaches the machining position shown in FIG. 2. Connection unit 40 moves along support beam 42 during the travel of second machine tool 24 to the machining position. In this position, in the non-limiting illustrated embodiment, second machine tool 24 is mounted on the machine table 16 and a workpiece 19 is mounted on second machine tool 24 (such as on a rotary table). Alternatively, second machine tool 24 could be mounted on the base 20 which may serve as another machine table, as needed.

Thus second machine tool 24 can be moved back and forth at will from the storage position (FIG. 1) to the machining position (FIG. 2) in order to increase the number of axes for linear and rotational manipulations of workpieces or tools, in a much more compact manner than the prior art. This provides significant savings in the cost of the machines themselves, and in the cost and space needed to store and convey them.

It is noted that any number of second machine tools of various kinds may be stored in a storage area of the first machine tool and conveyed to the machining position.

Summarizing the above-described embodiments, FIG. 1 illustrates second machine tool 24 stored, and a workpiece ready for 3D milling on the machine table. In the case of second machine tool 24 being a rotary device with five or more axes, FIG. 2 illustrates 5D milling of a workpiece on second machine tool 24, with an unused surface of the machine table ready for 3D milling when second machine tool 24 is not in use (e.g., after finishing the 5D milling operations).

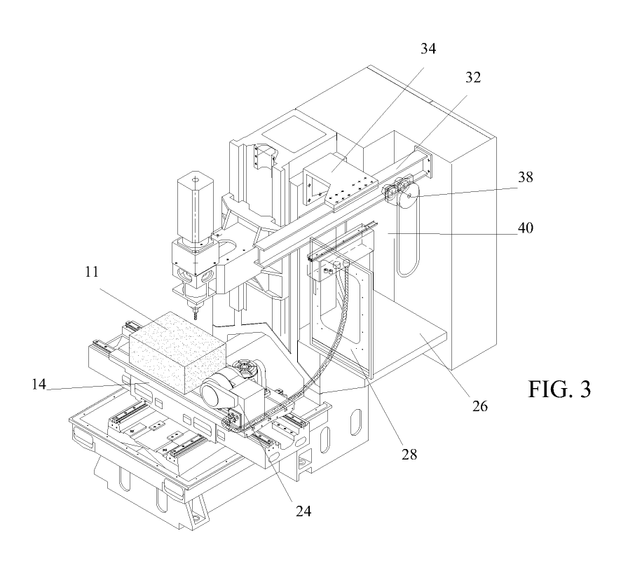

FIGS. 1 and 2 illustrate just some of the many other possibilities of using the machine tool assembly of the invention. As another example, FIG. 3 illustrates second machine tool 24 sitting idle on the machine table, and a relatively small workpiece clamped for 3D milling on a limited surface of the machine table.

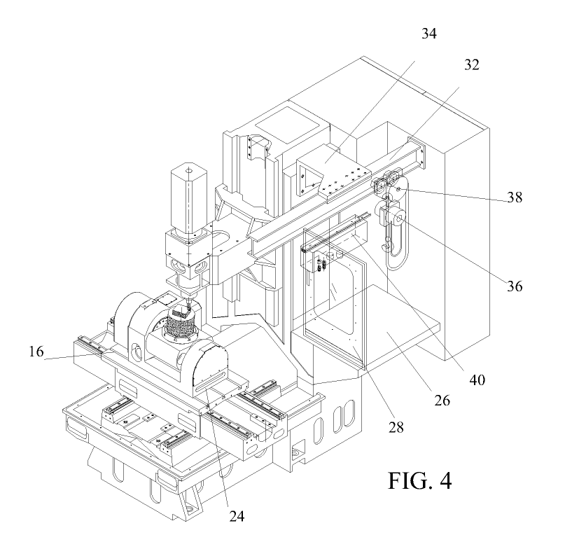

In yet another example, FIG. 4 illustrates a relatively large second machine tool 24 installed on the machine table for performing 5D machining of a workpiece, wherein no surface of the machine table is available for 3D milling.

Of course, as another example, when second machine tool 24 is stored, the entire machine table surface is available for 3D work (similar to that illustrated in FIG. 1).

The scope of the present invention includes both combinations and subcombinations of the features described hereinabove as well as modifications and variations thereof which would occur to a person of skill in the art upon reading the foregoing description and which are not in the prior art.

What is claimed is:

1. A machine tool assembly comprising:
a first machine tool comprising a spindle for holding a cutting tool and at least one machine table for mounting thereon a workpiece;
a second machine tool for mounting thereon a workpiece; and
a conveying unit for moving said second machine tool back and forth from a storage position in a storage compartment of said first machine tool to a machining position wherein said second machine tool is mounted on said at least one machine table of said first machine tool.

2. The machine tool assembly according to claim 1, wherein said first machine tool comprises a first machine table that moves along a first axis, said first machine table being slidingly mounted on a base for moving along a second axis orthogonal to said first axis.

3. The machine tool assembly according to claim 1, wherein said second machine tool comprises a rotary device capable of rotational manipulations with respect to a multiplicity of axes.

4. The machine tool assembly according to claim 1, wherein said storage compartment is provided with a door.

5. The machine tool assembly according to claim 1, wherein said conveying unit is supported from a hoist trolley, which is arranged to move along a trolley beam.

6. The machine tool assembly according to claim 1, further comprising a connection unit with cables for said second machine tool, said connection unit moving along a support beam.

7. A method for machining comprising:
providing a first machine tool comprising a spindle for holding a cutting tool and at least one machine table for mounting thereon a workpiece, a second machine tool for mounting thereon a workpiece, and a conveying unit for moving said second machine tool back and forth from a storage position in a storage compartment of said first machine tool to a machining position wherein said second machine tool is mounted on said at least one machine table of said first machine tool; and
using said conveying unit to convey said second machine tool from the storage position to the machining position and machining a workpiece.
